(19) United States
(12) Patent Application Publication
(10) Pub. No.: US 2026/0235634 A1
(43) Pub. Date: Aug. 13, 2026

(54) KITS AND SYSTEMS FOR CORRELATING DIFFERENT BIOLOGICAL SAMPLES

(71) Applicant: LEAVITT MEDICAL, INC., Lehi, UT (US)

(72) Inventor: Matthew O. Leavitt, Rochester Hills, MI (US)

(21) Appl. No.: 19/464,334

(22) Filed: Jan. 29, 2026

Related U.S. Application Data
(60) Provisional application No. 63/752,504, filed on Jan. 31, 2025.

(51) Int. Cl. G01N 35/00

(52) U.S. Cl. CPC G01N 35/00732; G01N 2035/00752

(57) ABSTRACT

A kit may include a first receptacle configured for receiving a first biological sample from a patient and a second receptacle configured for receiving a second biological sample from the patient. A first identifier may identify the first receptacle and a second identifier may identify the second receptacle. The first and second identifiers may be pre-correlated in a specimen management system for linking the first biological sample and the second biological sample. Related systems and methods are also disclosed.

### CROSS REFERENCE TO RELATED APPLICATION

This application claims priority to U.S. Provisional Patent Application No. 63/752,504, filed 31 January 2025, the entire contents of which are incorporated herein by reference.

### BRIEF DESCRIPTION OF DRAWINGS

The accompanying drawings illustrate a number of example embodiments and are a part of the specification. Together with the following description, these drawings demonstrate and explain various principles of the present disclosure.

FIG. 1 illustrates a kit including biological sample receptacles, according to at least one embodiment of the present disclosure.

FIG. 2 is a diagram illustrating a process for correlating biological sample receptacles, taking respective biological samples from a patient, processing the biological samples in different labs, and correlating the corresponding diagnostic results, according to at least one embodiment of the present disclosure.

FIG. 3 is a block diagram illustrating a specimen management system, according to at least one embodiment of the present disclosure.

FIG. 4 is a flow diagram illustrating a method for correlating diagnostic results from different biological samples from a single patient, according to at least one embodiment of the present disclosure.

While the example embodiments described herein are susceptible to various modifications and alternative forms, specific embodiments have been shown by way of example in the drawings and will be described in detail herein. However, the example embodiments described herein are not intended to be limited to the particular forms disclosed. Rather, the present disclosure covers all modifications, equivalents, and alternatives falling within this disclosure.

### DETAILED DESCRIPTION OF EXAMPLE EMBODIMENTS

In the field of medical diagnostics, biological samples (e.g., tissue biopsies, bodily fluid draws, etc.) are a tool for detecting and diagnosing various diseases, including cancer. Traditionally, tissue biopsies have been the standard for obtaining diagnostic information in many situations. These involve the extraction of tissue samples from a patient, which are then analyzed in a histopathology laboratory. Tissue biopsies may be referred to as “solid-phase” samples.

In recent years, liquid biopsies have emerged as an alternative or addition to tissue biopsies. Liquid biopsies involve the analysis of bodily fluids, such as blood, to detect circulating tumor cells (CTCs) and/or circulating tumor DNA (ctDNA). These biomarkers can provide valuable information about the presence and/or progression of cancer. Liquid biopsies are generally less invasive, can be performed more frequently, and offer the potential for early detection of disease.

In addition to liquid biopsies, other types of liquid-phase samples may also be analyzed for diagnostic purposes. For example, urine, bone marrow, saliva, pleural fluid, peritoneal fluid, pericardial fluid, and/or other bodily fluids may be liquid-phase samples. Such liquid-phase samples are usually processed for analysis in a laboratory using a different process than solid-phase samples. In some instances, solid-phase samples are processed in one laboratory or one section of a laboratory and liquid-phase samples are processed in a different laboratory or a different section of the laboratory. This can be true even when both solid-phase and liquid-phase samples are extracted from a single patient on the same day.

In one example, a bone marrow biopsy may start by extracting several different samples from a single patient, such as: a tube of blood to be sent to a hematology laboratory or section, a solid core of bone marrow sent to a histology laboratory or section, touch imprints (e.g., smears) on glass slides sent to a cytology laboratory or section, a tube of bone marrow in liquid phase sent to a histology laboratory or section, a tube of bone marrow in liquid phase sent to a flow cytometry laboratory or section, and a tube of bone marrow in liquid phase sent to a cytogenetics laboratory or lab section.

The present disclosure is generally directed to kits and systems that facilitate linking different biological samples (e.g., two or more different liquid-phase biopsy specimens, two or more different solid-phase (e.g., tissue) biopsy specimens, and/or one or more liquid-phase biopsy specimens together with one or more solid-phase biopsy specimens) to each other, facilitating comprehensive analysis and correlation of diagnostic data from both. The kits may include at least one first (e.g., liquid-phase) sample receptacle and at least one second (e.g., solid-phase) sample receptacle, each equipped with a unique identifier. These identifiers may be pre-correlated in a specimen management system, ensuring that corresponding biological specimens and their diagnostic results can be linked regardless of where, when, or how they are processed. The specimen management system may include a digital platform for integrating and managing the data from the multiple types of biopsies. This system addresses the current challenges in correlating results from different types of biopsies, which are often processed at different times and/or at different laboratories. Kits according to the present disclosure, with pre-correlated liquid-phase and/or solid-phase biopsy identifiers, and associated systems can also be helpful for diagnostic verification and confidence in results.

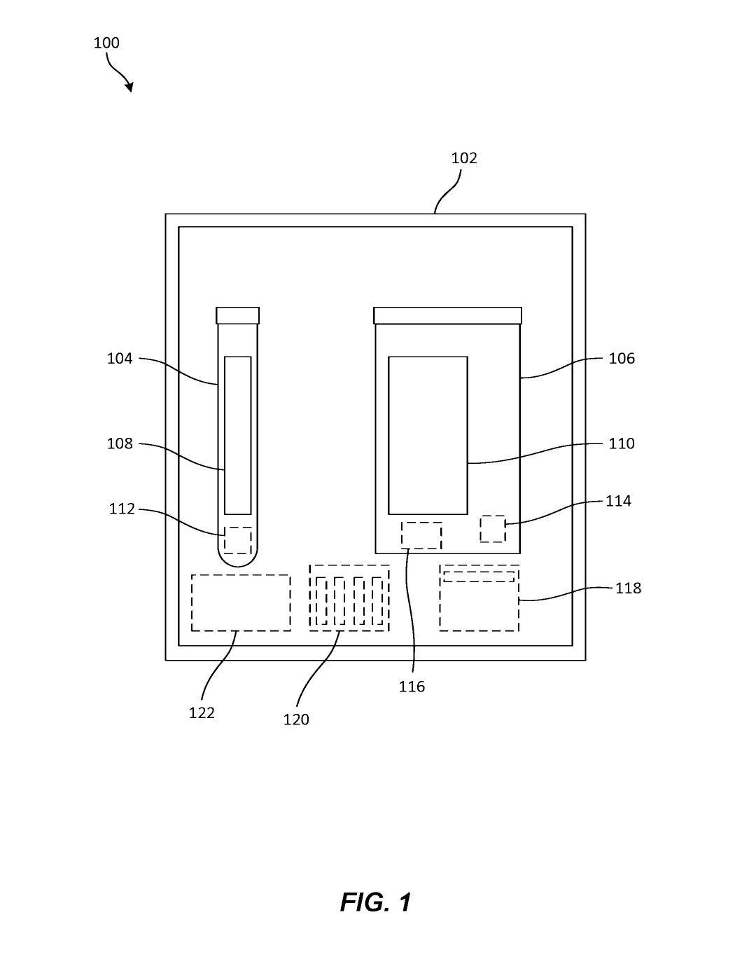

As illustrated in FIG. 1, in some examples, a kit 100 according to the present disclosure may include a sterile enclosure 102, a first receptacle 104 for receiving a first biological sample from a patient, a first identifier 108 for identifying the first receptacle 104, a second receptacle 106 configured for receiving a second biological sample from the patient, and a second identifier 110 for identifying the second receptacle 106. The first identifier 108 and the second identifier 110 may be pre-correlated (e.g., linked to each other) in a specimen management system for linking the first biological sample and the second biological sample.

By way of example and not limitation, the first receptacle 104 will be described herein as a liquid receptacle for receiving a liquid-phase biological sample and the second receptacle 106 will be described herein as a tissue receptacle for receiving a solid-phase biological sample. However, the present disclosure is not so limited. In additional examples, the kit 100 according to embodiments of the present disclosure may include more than one liquid receptacle and/or more than one tissue receptacle that may be destined for different processing (e.g., at different laboratories, at different sections and/or workflows of a laboratory, etc.). Each of the liquid receptacle(s) and/or tissue receptacle(s) may include a unique identifier that is pre-correlated to the other(s) in a specimen management system.

In one example, the first receptacle 104 may be configured to receive a liquid-phase sample, such as a blood sample or other bodily fluid sample, from a patient. The first receptacle 104 may be equipped with the first identifier 108, which can be a one-dimensional barcode, a two-dimensional barcode, an alphanumeric code, a serial number, a first radio-frequency identification (RFID) tag 112, or the like. In some examples, the first identifier 108 may be or include a label affixed to the first receptacle 104 that includes a barcode, alphanumeric code, serial number, embedded RFID tag 112, etc.

In the example illustrated in FIG. 1, the second receptacle 106 may be designed to receive a solid-phase sample from the patient, such as a sample of the patient’s prostate, breast, skin, kidney, lung, brain, muscle, bone, etc. For example, the second receptacle 106 may include a tissue cassette, a bottle (e.g., containing a tissue preservative such as formalin), and/or the like. Another example of a suitable second receptacle 106 may be the tissue receptacle explained in U.S. Patent No. 11,173,489, the entire disclosure of which is incorporated herein by reference. For example, the second receptacle 106 may be or include a traditional tissue sample cassette 118 or may be a cassette that includes an upper tray including compartments separated by dividers, a lower tray coupled to the upper tray and having a central recess, and an absorbent material (e.g., sponge) located in the recess of the lower tray. By way of example and not limitation, the compartments may be elongated to receive needle core biopsy specimens.

The second receptacle 106 may be equipped with the second identifier 110, which can be similar to the first identifier 108 (e.g., a barcode, alphanumeric code, serial number, a second RFID tag 114, or the like). In some examples, the second identifier 110 may be or include a label affixed to the second receptacle 106 that includes a barcode, alphanumeric code, serial number, embedded RFID tag 114, etc.

In additional examples, the second identifier 110 may include a sectionable tag 116 and/or a sectionable tissue-support matrix 120 that incorporates the second identifier 110. In the case of the sectionable tag 116 and/or sectionable tissue-support matrix 120, the second identifier 110 may remain with the tissue sample throughout histological processing and sectioning to be identifiable during the processing and/or in images of sections of biological material (e.g., whole slide images). Examples of a suitable sectionable material that may be used in the sectionable tag 116 and/or sectionable tissue-support matrix 120 are explained in U.S. Patent No. 9,851,349, the entire disclosure of which is incorporated herein by reference. For example, the sectionable tissue-support matrix 120 may incorporate distinctive identifiers, such as barcodes and/or alphanumeric codes, which remain intact and identifiable throughout histological processing and/or sectioning of biological samples. This advanced matrix material facilitates the identification and tracking of tissue samples during microscopic analysis, ensuring that diagnostic data can be accurately correlated with the original specimen. The sectionable material is compatible with standard histopathology techniques, including embedding, slicing, and staining, and provides a dependable means of maintaining sample integrity and traceability throughout laboratory workflows. In some examples, the sectionable material may be formed of a mixture of lipids and proteins tailored and/or selected to mimic the biological sample, such as to shrink and/or expand at substantially the same rate as the biological sample during histological processing.

Examples of sectionable code that may be used with the sectionable tag 116 or sectionable tissue-support matrix 120 are explained in U.S. Patent No. 10,734,100, the entire disclosure of which is incorporated herein by reference. For example, the sectionable code may include a portion of sectionable material and/or a gap in the sectionable material that is shaped into a unique identifier, such as a barcode and/or an alphanumeric code. These identifiers may remain intact and identifiable throughout histological processing, including embedding, slicing, staining, and sectioning. By preserving the integrity of the identifier, the system enables accurate tracking and correlation of diagnostic data with the original specimen, improving traceability and reliability in laboratory workflows. This approach addresses challenges in sample identification during microscopic analysis and provides an effective solution for maintaining diagnostic accuracy across complex histopathology procedures.

In some examples, the kit 100 may include one or more components (e.g., a filter, a sectionable matrix material, and/or a vial, etc.) for processing a cytological sample. In one example, a cytological sample may be processed by a system and/or method described in U.S. Patent No. 10,962,454, the entire disclosure of which is incorporated herein by reference. For example, the kit 100 may include one or more filters (e.g., concave filters) for capturing cells suspended in a liquid cytological sample. Additionally or alternatively, the kit 100 may one or more sectionable matrix materials shaped (e.g., with a concave surface) to accept the filter(s) and/or cytological samples.

Optionally, the kit 100 may also include other components 122 useful for taking a liquid-phase sample and/or a solid-phase sample from the patient, such as a syringe, a needle, a surgical tool, gauze, a bandage, a sponge, a tissue preservative (e.g., formalin), and the like.

In some examples, the kit 100 may include more than two receptacles 104, 106, each with its own unique, pre-correlated identifier 108, 110. For example, the kit 100 may include two, three, four, five, six, or more different receptacles, depending on a type of diagnostic toolset that a physician desires for a particular patient.

Before the kit 100 is distributed to a user (e.g., to collection site, such as a hospital or clinic for liquid-phase sample and/or solid-phase sample collection), the first identifier 108 and second identifier 110 may be pre-correlated in a specimen management system. This pre-correlation may link a first biological specimen received in the first receptacle 104 and a second biological specimen received in the second receptacle 106, and ultimately their respective diagnostic results and/or the patient from which the samples were taken, in the specimen management system regardless of when or where they are processed.

For example, after the first and second identifiers 108, 110 are pre-correlated, the kit 100 may be used at a clinic to take multiple biological samples (e.g., one or more liquid-phase samples and/or one or more solid-phase samples) from a patient. For example, a first sample in the first receptacle 104 may be sent for processing from the clinic to a first laboratory or lab section designed to process the same type of biological sample as the first sample. For example, in the case of a liquid-phase biopsy, this first laboratory may analyze the liquid biopsy sample for circulating tumor cells and/or circulating tumor DNA. Meanwhile, a second sample in the second receptacle 106 may be sent for processing from the clinic to a second laboratory or lab section, which may be separate from the first laboratory (or a separate section of a same first laboratory) for processing the same type of biological sample as the second sample. For example, in the case of a solid-phase sample, the second sample may be sent to a histology lab.

Diagnostic results (e.g., whole slide and/or gross images, measurements, diagnoses, pathologist notes, etc.) relating to the first sample may be uploaded to the specimen management system through association with the first identifier 108. Likewise, diagnostic results (e.g., slide and/or gross images, measurements, diagnoses, pathologist notes, etc.) relating to the second sample may be uploaded to the specimen management system through association with the second identifier 110. Since the first identifier 108 and second identifier 110 were pre-correlated in the specimen management system, the results of the multiple laboratory analyses may also be correlated with each other to form a correlated record (e.g., correlated diagnostic data).

By accessing the correlated record in the specimen management system, the first (e.g., liquid-phase) laboratory may review information relating to the second sample and the second (e.g., histology) laboratory may review information relating to the first sample, such as to compare, validate, and/or confirm results, to identify whether cancerous cells have metastasized or are likely to metastasize, etc. In some examples, one or more pathologists and/or the patient’s physician may be able to access the correlated record in the specimen management system to determine whether additional tests would be helpful, to communicate the results to the patient, and/or to generate a treatment plan. Likewise, in some examples, a pharmaceutical supplier or developer may be able to use the correlated data (e.g., that has been anonymized and/or aggregated) to suggest or develop improved medications. In another example, a test developer may use correlated data from the specimen management system to identify whether certain types and stages of a particular disease are amenable to detection through liquid-phase analysis and/or solid-phase analysis.

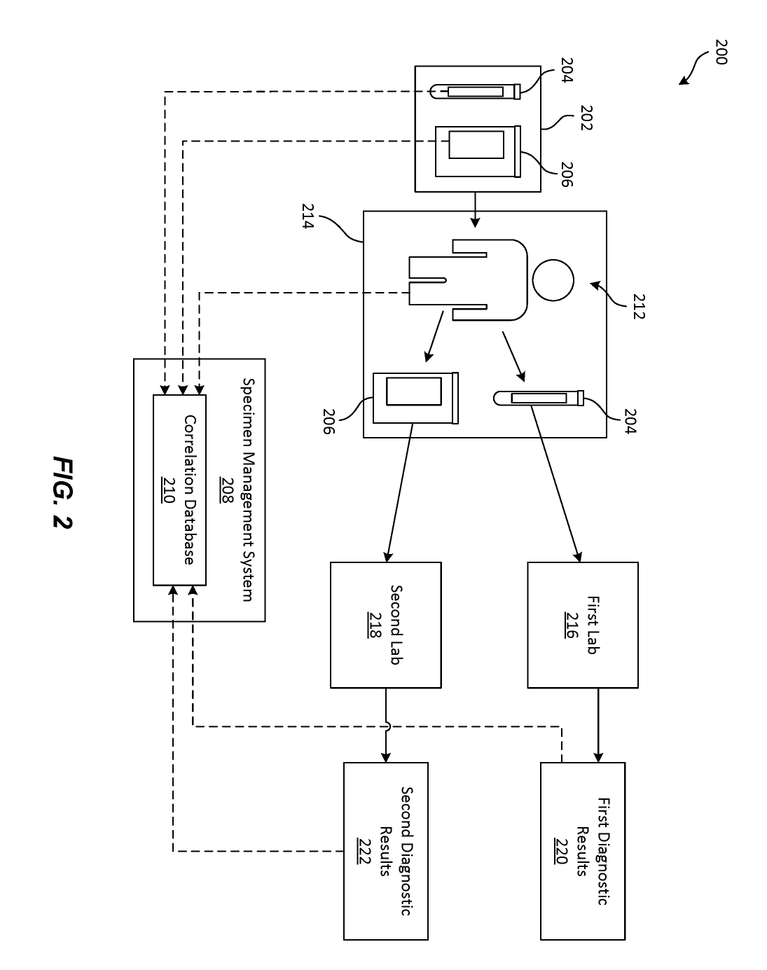

FIG. 2 is a diagram illustrating a process 200 for correlating biological sample receptacles, taking respective biological samples from a patient, processing the biological samples in different labs, and correlating the corresponding diagnostic results, according to at least one embodiment of the present disclosure.

A kit 202 may include a first receptacle 204 and a second receptacle 206 for collecting respective biological samples from a patient 212 that are destined for different analysis procedures. In some embodiments, the kit 202 may include more than two receptacles, each adapted to receive distinct types of samples. For example, the kit 202 can be configured to ensure that samples collected from the patient 212 at a collection site 214 are properly identified and correlated through specific respective identifiers associated with the first receptacle 204 and second receptacle 206. These identifiers may be pre-correlated within a specimen management system 208, thereby enabling integration and analysis of diagnostic data obtained from disparate laboratories.

In some embodiments, the first receptacle 204 may serve as a dedicated container for a specific type of biological sample, such as a liquid-phase specimen (e.g., blood, cellular suspension, other bodily fluid, etc.) obtained from the patient 212. The first receptacle 204 can include an identifier that is pre-correlated with another identifier of the second receptacle 206 in the specimen management system 208. Accordingly, the first receptacle 204 may facilitate accurate tracking of the sample collected into the first receptacle 204 and correlation with first diagnostic results 220 generated by a first lab 216. These first diagnostic results 220 can be received by the specimen management system 208.

In some embodiments, the second receptacle 206 may serve as a dedicated container for a different biological sample type, for instance, a solid-phase specimen (e.g., tissue biopsy specimen, bone specimen, etc.) collected from the patient 212. Similar to the first receptacle 204, the second receptacle 206 may be equipped with an identifier that is pre-correlated with the identifier of the first receptacle 204. As a result, the second lab 218 can process the sample collected into the second receptacle 206 to generate second diagnostic results 222 that are also received by the specimen management system 208. The first diagnostic results 220 and the second diagnostic results 222 may be associated with each other within the specimen management system 208.

In some embodiments, the collection site 214 may represent the facility (e.g., a clinic, a hospital, etc.) where the biological specimens are initially obtained from the patient 212. For example, the collection site 214 can be equipped to handle both liquid-phase and solid-phase samples, ensuring that each specimen is correctly labeled and forwarded to the appropriate laboratory for processing.

In some embodiments, the first lab 216 may represent the facility responsible for analyzing the specimen received in the first receptacle 204. For example, the first lab 216 may perform specific assays to generate first diagnostic results 220, which can be uploaded to the specimen management system 208. These results may then be correlated with the distinct identifier of the first receptacle 204, allowing integration with results from the second lab 218.

In some embodiments, the second lab 218 may represent the facility that processes the specimen contained within the second receptacle 206. For example, the second lab 218 may conduct assays to produce second diagnostic results 222, which can also be uploaded to the specimen management system 208. Such correlation may ensure that the second diagnostic results 222 are linked to the pre-correlated identifier of the second receptacle 206, thereby facilitating comprehensive data integration.

The first lab 216 and the second lab 218 can represent distinct entities or operational divisions within a diagnostic workflow. For example, the first lab 216 may be a separate laboratory specializing in liquid-phase analysis, such as detecting circulating tumor cells (CTCs) or circulating tumor DNA (ctDNA) from blood samples, while the second lab 218 may focus on solid-phase analysis, such as histopathological examination of tissue biopsies. Alternatively, the first lab 216 and the second lab 218 may be separate sections within a single laboratory, each dedicated to different biological analysis processes. For instance, one section may handle molecular profiling of liquid-phase samples, while another section may perform microscopic imaging and/or staining of solid-phase samples. These distinct laboratories or sections may employ specialized equipment and methodologies tailored to the type of biological specimen being analyzed, ensuring precise and reliable diagnostic results. Furthermore, the separation of these processes allows for optimized workflows and expertise in handling specific sample types, while the specimen management system 208 ensures correlation of diagnostic data (e.g., the first and second diagnostic results 220, 222) across these disparate entities and/or process flows.

The first diagnostic results 220 may constitute an analytical output generated by the first lab 216 from the specimen in the first receptacle 204. In some embodiments, these first diagnostic results 220 may be used for understanding the biological status of the patient 212 and can be stored in the specimen management system 208, where they may be correlated with the second diagnostic results 222 to provide a comprehensive view of the patient’s condition.

The second diagnostic results 222 may constitute the analytical output produced by the second lab 218 from the specimen in the second receptacle 206. In some embodiments, these second diagnostic results 222 may complement the first diagnostic results 220 and can be integrated into the specimen management system 208. As a result, the combined dataset may offer a detailed diagnostic profile that supports diagnosis and treatment planning.

Accordingly, the specimen management system 208 may represent a digital platform that manages the correlation of diagnostic data (e.g., the first and second diagnostic results 220, 222) derived from multiple biological samples. For example, the system 208 can include a correlation database 210 storing the pre-correlated identifiers of the first and second receptacles 204, 206, thereby ensuring that the first and second diagnostic results 220, 222 from the first lab 216 and the second lab 218 are accurately linked. Such integration may enhance diagnostic accuracy by providing a unified view of the patient’s diagnostic data.

In some embodiments, the correlation database 210 may further correlate the first and second diagnostic results 220, 222 to each other and to the pre-correlated identifiers, and ultimately to a record of the patient 212.

In some embodiments, “diagnostic results” or “diagnostic results data” refers to information generated from the analysis of biological samples, which may include diagnoses, identification of specific cells or biomarkers of interest, pathology images, molecular profiling data, and/or quantitative measurements. This data can be used to assess the presence, progression, and/or characteristics of diseases, such as cancer, and may encompass various formats, including textual reports, imaging files, and numerical datasets.

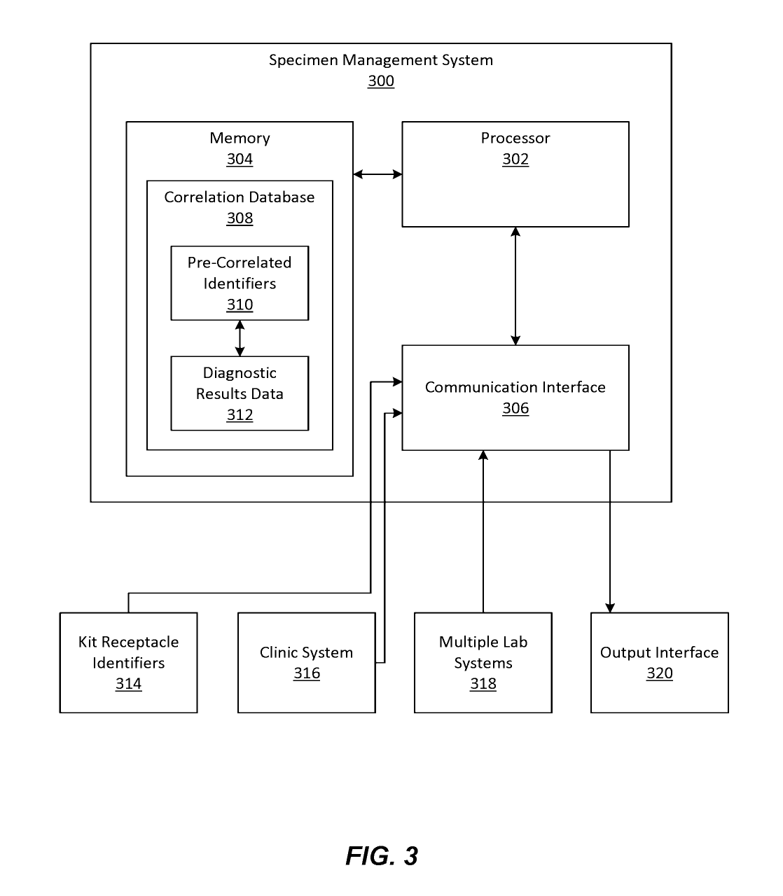

FIG. 3 is a block diagram illustrating a specimen management system 300, according to at least one embodiment of the present disclosure.

In some embodiments, the specimen management system 300 may represent a comprehensive digital platform configured to manage and correlate diagnostic data from various biological samples. The specimen management system 300 may integrate multiple components to ensure accurate tracking and analysis of samples from collection to diagnosis. Accordingly, the specimen management system 300 may coordinate data flow and maintain referential integrity across modules that make up the specimen management system 300.

The specimen management system may include a processor 302, memory 304, and a communication interface 306. In some embodiments, the processor 302 may serve as the central processing unit of the specimen management system 300, executing instructions and managing data flow between components. For example, the processor 302 may process incoming data, perform correlation tasks, and ensure that diagnostic results data 312 are accurately linked to their respective pre-correlated identifiers 310. Furthermore, the processor 302 may execute algorithms that merge datasets, align heterogeneous data types, and/or perform quality checks to maintain data integrity.

The memory 304 may serve as a storage medium for the specimen management system 300, housing data and instructions that can be used for system operation. For example, the memory 304 may include a correlation database 308, which may store pre-correlated identifiers 310 and diagnostic results data 312. As a result, the memory 304 may ensure that data is readily accessible for processing and retrieval, supporting the ability of the specimen management system 300 to manage large volumes of diagnostic information efficiently.

In some embodiments, the correlation database 308 may represent a specialized component within the memory 304 that is configured to store and manage pre-correlated identifiers 310. These pre-correlated identifiers 310 may link biological samples to their respective diagnostic results data 312, thereby enabling data integration. In addition, the correlation database 308 may store the diagnostic results data 312 to ensure that all relevant information is available for comprehensive analysis and correlation. The diagnostic results data 312 from a particular patient may be correlated to the pre-correlated identifiers 310 of sample receptacles used in connection with the patient sample collection.

The pre-correlated identifiers 310 may include distinct codes associated with each sample receptacle, enabling the specimen management system 300 to link samples and their diagnostic results data 312 accurately. For example, these pre-correlated identifiers 310 may be established prior to sample collection, ensuring that data from different laboratories can be correlated within the specimen management system 300.

The diagnostic results data 312 may include the analytical outputs and/or other data generated from the processing of biological samples. In some embodiments, this diagnostic results data 312 may include pathology images, molecular profiling data, diagnostic information, pathologist notes, etc., which may be stored in the correlation database 308 for integration and analysis.

In some embodiments, the communication interface 306 may enable secure data exchange between the specimen management system 300 and external entities, such as clinic systems 316 and multiple lab systems 318. The communication interface 306 may receive diagnostic results data 312 from the multiple lab systems 318 that process biological samples in pre-correlated sample receptacles. The communication interface 306 may transmit correlated data to authorized users (e.g., the patient, the patient’s physician, a pathologist, etc.), supporting secure data transfer protocols to maintain the confidentiality and integrity of sensitive information.

In some embodiments, kit receptacle identifiers 314 may be used for distinct identification for each sample receptacle. These kit receptacle identifiers 314 of a respective kit may be pre-correlated within the specimen management system 300, ensuring that samples collected at the clinic system 316 from each kit are accurately tracked and linked to their corresponding diagnostic results data 312.

The clinic system 316 may represent the facility where biological samples are initially collected from patients. In some embodiments, the clinic system 316 may interface with the specimen management system 300 to ensure that samples are correctly labeled and forwarded to the appropriate multiple lab systems 318 for processing.

The multiple lab systems 318 may encompass the various laboratories and/or diagnostic processes configured for analyzing the collected samples. These multiple lab systems 318 may interface with the specimen management system 300 to upload diagnostic results data 312, which may then be correlated with the pre-correlated identifiers 310.

The output interface 320 may provide a means for users to access the correlated diagnostic results data 312. For example, the output interface 320 may present integrated information to physicians, pathologists, researchers, and/or other stakeholders, enabling informed decision-making and enhancing diagnostic accuracy. Furthermore, the output interface 320 may ensure that comprehensive diagnostic profiles are available for review and analysis.

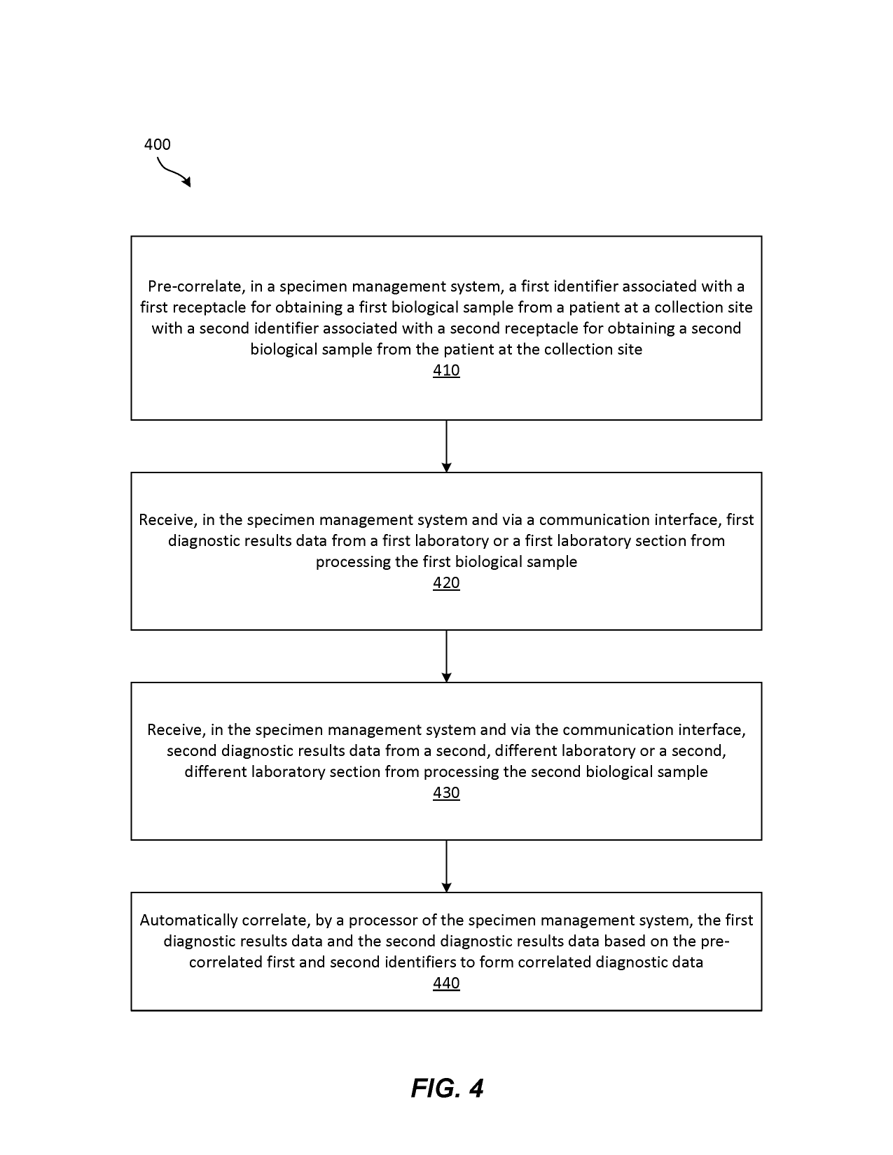

FIG. 4 is a flow diagram illustrating a method 400 for correlating diagnostic results from different biological samples from a single patient, according to at least one embodiment of the present disclosure. The method 400 can ensure that data derived from multiple specimen diagnostic procedures are cohesively linked and analyzed to provide a consolidated diagnostic output.

At operation 410, a first identifier associated with a first receptacle (e.g., a first biological specimen receptacle) may be pre-correlated with a second identifier associated with a second receptacle (e.g., a second biological specimen receptacle) in a specimen management system. The first receptacle may be a first biological specimen receptacle for obtaining a first biological specimen from a patient at a collection site, such as a clinic or hospital. The second receptacle may be a second biological specimen receptacle for obtaining a second biological specimen from the same patient at the same collection site. The first receptacle and the second receptacle may be included in a common kit, as described above. Operation 410 may be performed in a variety of ways. For example, the specimen management system may generate the pre-correlation by creating a database entry that stores the first identifier and the second identifier as a linked pair prior to distribution of the common kit to the collection site. In another example, the pre-correlation may be embedded in machine-readable media (e.g., barcodes, QR codes, RFID tags, etc.) affixed to or included in the respective receptacles, with a corresponding association stored in the system (e.g., in a database of the specimen management system) so that scanning either identifier automatically retrieves the linked pair. In another example, the pre-correlation may be established through a provisioning workflow in which a user interface presents a kit configuration screen, receives the first and second identifiers, and commits the association to a secure record (e.g., with timestamp, operator credentials, and/or audit metadata). In further examples, labels with unique identifiers may be pre-correlated in the specimen management system and then affixed to the first receptacle and to the second receptacle, respectively.

In some embodiments, the first biological specimen may be a liquid-phase specimen and the second biological specimen may be a solid-phase specimen. In additional embodiments, the first biological specimen may be a solid-phase specimen and the second biological specimen may be a liquid-phase specimen. In some embodiments, both the first and second biological specimens may be liquid-phase specimens or solid-phase specimens destined for different histopathology laboratory processes and/or locations.

Accordingly, although the kits and systems of the present disclosure are sometimes described in the context of processing liquid-phase and solid-phase samples from a patient, the present disclosure is not so limited. In additional examples, kits and systems of the present disclosure may be configured for correlating and processing two or more different liquid-phase samples and/or two or more different solid-phase samples from a single patient. For example, a kit may include a first liquid receptacle with a first identifier and a second liquid receptacle with a second identifier. The first and second identifiers may be pre-correlated with each other in a specimen management system. In another example, a kit may include a first tissue (e.g., solid tissue) receptacle with a first identifier and a second tissue receptacle with a second identifier, with the first and second identifiers pre-correlated with each other in a specimen management system.

At operation 420, first diagnostic results data from a first laboratory (or section of a laboratory) from processing the first biological sample may be received in the specimen management system via a communication interface. Operation 420 may be performed in a variety of ways. For example, the communication interface may receive the first diagnostic results data via one or more secure network protocols and automatically associate the incoming first diagnostic results data with the first identifier. In some examples, the first laboratory (or lab section) may upload the first diagnostic results data through a web portal or API, and the specimen management system may parse the file, validate data integrity, and map the contents to the first identifier. In yet another example, a laboratory instrument (e.g., a scanner, etc.) may stream results in real time to the specimen management system, which buffers the data, performs format normalization, and commits the validated results to a database entry linked to the first identifier.

At operation 430, second diagnostic results data from a second laboratory (or section of the laboratory) from processing the second biological sample may be received in the specimen management system via the communication interface. Operation 430 may be performed in a variety of ways, such as any of the ways described above with reference to operation 420.

At operation 440, the first diagnostic results data and the second diagnostic results data may be automatically correlated based on the pre-correlated first and second identifiers to form correlated diagnostic data. For example, a processor of the specimen management system may perform operation 440. Operation 440 may be performed in a variety of ways. For example, the processor may retrieve the linked pair of identifiers from the database and execute a rules engine that merges datasets sharing the pre-correlated identifiers into a unified record. In another example, the processor may apply schema mapping to align heterogeneous data types (e.g., imaging files, molecular profiling tables, etc.) and generate a consolidated data object keyed to the linked identifiers. In yet another example, the processor may perform temporal and quality checks to confirm that both datasets correspond to the same patient and/or patient encounter before committing the correlated diagnostic data to persistent storage and flagging it for presentation via an output interface.

Accordingly, the disclosed concepts provide a unified kit and platform solution that pre-correlates identifiers across multiple specimen receptacles and seamlessly links multiple liquid-phase and/or solid-phase diagnostic results generated via different laboratories or sections of laboratories. The disclosed specimen management system may securely ingest results via standardized interfaces, map them to pre-correlated identifiers stored in a correlation database, and automatically create a consolidated record that preserves the data and enables comparative review. This architecture improves traceability from collection through analysis, reduces labeling and data-entry errors, and facilitates multidisciplinary workflows by presenting integrated pathology images, molecular profiling data, and/or quantitative measurements in a single view. As a result, clinicians, pathologists, and/or researchers can validate and confirm findings more efficiently, enhance diagnostic accuracy, and support more timely and informed treatment decisions, while institutions gain auditability, interoperability, and scalability across diverse laboratory environments.

The following example embodiments are also included in the present disclosure.

Example 1. A kit, including: a first receptacle configured for receiving a first biological sample from a patient; a first identifier for identifying the first receptacle; a second receptacle configured for receiving a second biological sample from the patient; and a second identifier for identifying the second receptacle, wherein: the first identifier and the second identifier are pre-correlated in a specimen management system for linking the first biological sample and the second biological sample.

Example 2. The kit of Example 1, wherein: the first receptacle includes a liquid receptacle configured for receiving a liquid-phase sample from the patient; and the second receptacle includes a tissue receptacle configured for receiving a solid-phase sample from the patient.

Example 3. The kit of Example 2, wherein the first receptacle includes a blood vial.

Example 4. The kit of Example 2 or Example 3, further including a sectionable tag including the second identifier, the sectionable tag configured for being processed and sectioned along with the solid-phase sample received in the tissue receptacle.

Example 5. The kit of any one of Examples 2 through 4, wherein the tissue receptacle includes a sectionable tissue-support matrix including the second identifier, the sectionable tissue-support matrix configured for being processed and sectioned along with the solid-phase sample received.

Example 6. The kit of any one of Examples 2 through 5, wherein the tissue receptacle includes a tissue sample cassette.

Example 7. The kit of any one of Examples 2 through 6, wherein the tissue receptacle includes a container containing a tissue preservative.

Example 8. The kit of Example 7, wherein the tissue preservative includes formalin.

Example 9. The kit of any one of Examples 1 through 8, wherein: the first receptacle includes a first liquid receptacle configured for receiving a first liquid-phase sample from the patient; and the second receptacle includes a second liquid receptacle configured for receiving a second liquid-phase sample from the patient.

Example 10. The kit of any one of Examples 1 through 8, wherein: the first receptacle includes a first solid receptacle configured for receiving a first solid-phase sample from the patient; and the second receptacle includes a second solid receptacle configured for receiving a second solid-phase sample from the patient.

Example 11. The kit of any one of Examples 1 through 10, wherein the first identifier includes a label including at least one of: a one-dimensional barcode; a two-dimensional barcode; an alphanumeric code; or a serial number.

Example 12. The kit of any one of Examples 1 through 11, wherein the second identifier includes a label including at least one of: a one-dimensional barcode; a two-dimensional barcode; an alphanumeric code; a serial number; a sectionable tag; or a sectionable tissue-support matrix.

Example 13. The kit of any one of Examples 1 through 12, wherein the first identifier includes a radio-frequency identification (RFID) tag.

Example 14. The kit of any one of Examples 1 through 13, wherein the second identifier includes a radio-frequency identification (RFID) tag.

Example 15. A specimen management system, including: a memory configured to store a database of pre-correlated identifiers including a first identifier associated with a first sample receptacle configured for receiving a first biological sample from a patient and a second identifier associated with a second sample receptacle configured for receiving a second biological sample from the patient; a communication interface configured to receive first diagnostic results data generated from the first biological sample in association with the first identifier from a first laboratory process and to receive second diagnostic results data generated from the second biological sample in association with the second identifier from a second, different laboratory process; and a processor coupled to the memory and the communication interface, the processor configured to automatically correlate the first diagnostic results data and the second diagnostic results data in accordance with the pre-correlated identifiers.

Example 16. The specimen management system of Example 15, further including an output interface configured to present the correlated diagnostic data to a user.

Example 17. The specimen management system of Example 15 or Example 16, wherein: the first diagnostic results data includes pathology image data and the second diagnostic results data includes molecular profiling data; and the processor is configured to correlate the pathology image data with the molecular profiling data.

Example 18. The specimen management system of any one of Examples 15 through 17, wherein the communication interface is configured to receive the first diagnostic results data from a first laboratory or a first laboratory section performing the first laboratory process and the second diagnostic results data from a second laboratory or a second laboratory section performing the second laboratory process.

Example 19. A method for correlating diagnostic results from two or more biological samples, the method including: pre-correlating, in a specimen management system, a first identifier of a first receptacle for obtaining a first biological sample from a patient at a collection site with a second identifier of a second receptacle for obtaining a second biological sample from the patient at the collection site; receiving, in the specimen management system and from a first laboratory or a first laboratory section, first diagnostic results data from processing the first biological sample; receiving, in the specimen management system and from a second, different laboratory or a second, different laboratory section, second diagnostic results data from processing the second biological sample; and automatically correlating, by the specimen management system, the first diagnostic results data and the second diagnostic results data based on the pre-correlated first and second identifiers to form correlated diagnostic data.

Example 20. The method of Example 19, wherein the first biological sample is a liquid-phase sample and the second biological sample is a solid-phase sample.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various example methods described and/or illustrated herein may also omit one or more of the steps described or illustrated herein or include additional steps in addition to those disclosed.

The preceding description has been provided to enable others skilled in the art to best utilize various aspects of the example embodiments disclosed herein. This example description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to any claims appended hereto and their equivalents in determining the scope of the present disclosure.

Unless otherwise noted, the terms “connected to” and “coupled to” (and their derivatives), as used in the specification and/or claims, are to be construed as permitting both direct and indirect (i.e., via other elements or components) connection. In addition, the terms “a” or “an,” as used in the specification and/or claims, are to be construed as meaning “at least one of.” Finally, for ease of use, the terms “including” and “having” (and their derivatives), as used in the specification and/or claims, are interchangeable with and have the same meaning as the word “comprising.”

What is claimed is:

1. A kit, comprising:
a first receptacle configured for receiving a first biological sample from a patient;
a first identifier for identifying the first receptacle;
a second receptacle configured for receiving a second biological sample from the patient; and
a second identifier for identifying the second receptacle, wherein:
the first identifier and the second identifier are pre-correlated in a specimen management system for linking the first biological sample and the second biological sample.

2. The kit of claim 1, wherein:
the first receptacle comprises a liquid receptacle configured for receiving a liquid-phase sample from the patient; and
the second receptacle comprises a tissue receptacle configured for receiving a solid-phase sample from the patient.

3. The kit of claim 2, wherein the first receptacle comprises a blood vial.

4. The kit of claim 2, further comprising a sectionable tag including the second identifier, the sectionable tag configured for being processed and sectioned along with the solid-phase sample received in the tissue receptacle.

5. The kit of claim 2, wherein the tissue receptacle comprises a sectionable tissue-support matrix including the second identifier, the sectionable tissue-support matrix configured for being processed and sectioned along with the solid-phase sample received.

6. The kit of claim 2, wherein the tissue receptacle comprises a tissue sample cassette.

7. The kit of claim 2, wherein the tissue receptacle comprises a container containing a tissue preservative.

8. The kit of claim 7, wherein the tissue preservative comprises formalin.

9. The kit of claim 1, wherein:
the first receptacle comprises a first liquid receptacle configured for receiving a first liquid-phase sample from the patient; and
the second receptacle comprises a second liquid receptacle configured for receiving a second liquid-phase sample from the patient.

10. The kit of claim 1, wherein:
the first receptacle comprises a first solid receptacle configured for receiving a first solid-phase sample from the patient; and
the second receptacle comprises a second solid receptacle configured for receiving a second solid-phase sample from the patient.

11. The kit of claim 1, wherein the first identifier comprises a label including at least one of:
a one-dimensional barcode;
a two-dimensional barcode;
an alphanumeric code; or
a serial number.

12. The kit of claim 1, wherein the second identifier comprises a label including at least one of:
a one-dimensional barcode;
a two-dimensional barcode;
an alphanumeric code;
a serial number;
a sectionable tag; or
a sectionable tissue-support matrix.

13. The kit of claim 1, wherein the first identifier comprises a radio-frequency identification (RFID) tag.

14. The kit of claim 1, wherein the second identifier comprises a radio-frequency identification (RFID) tag.

15. A specimen management system, comprising:
a memory configured to store a database of pre-correlated identifiers including a first identifier associated with a first sample receptacle configured for receiving a first biological sample from a patient and a second identifier associated with a second sample receptacle configured for receiving a second biological sample from the patient;
a communication interface configured to receive first diagnostic results data generated from the first biological sample in association with the first identifier from a first laboratory process and to receive second diagnostic results data generated from the second biological sample in association with the second identifier from a second, different laboratory process; and
a processor coupled to the memory and the communication interface, the processor configured to automatically correlate the first diagnostic results data and the second diagnostic results data in accordance with the pre-correlated identifiers.

16. The specimen management system of claim 15, further comprising an output interface configured to present the correlated diagnostic data to a user.

17. The specimen management system of claim 15, wherein:
the first diagnostic results data comprises pathology image data and the second diagnostic results data comprises molecular profiling data; and
the processor is configured to correlate the pathology image data with the molecular profiling data.

18. The specimen management system of claim 15, wherein the communication interface is configured to receive the first diagnostic results data from a first laboratory or a first laboratory section performing the first laboratory process and the second diagnostic results data from a second laboratory or a second laboratory section performing the second laboratory process.

19. A method for correlating diagnostic results from two or more biological samples, the method comprising:
pre-correlating, in a specimen management system, a first identifier of a first receptacle for obtaining a first biological sample from a patient at a collection site with a second identifier of a second receptacle for obtaining a second biological sample from the patient at the collection site;
receiving, in the specimen management system and from a first laboratory or a first laboratory section, first diagnostic results data from processing the first biological sample;
receiving, in the specimen management system and from a second, different laboratory or a second, different laboratory section, second diagnostic results data from processing the second biological sample; and
automatically correlating, by the specimen management system, the first diagnostic results data and the second diagnostic results data based on the pre-correlated first and second identifiers to form correlated diagnostic data.

20. The method of claim 19, wherein the first biological sample is a liquid-phase sample and the second biological sample is a solid-phase sample.
